(19) United States
(12) Patent Application Publication
(10) Pub. No.: US 2010/0151099 A1
(43) Pub. Date: Jun. 17, 2010

(54) METHOD OF GAS INFUSION DURING PREPARATION OF FOOD PRODUCTS

(76) Inventor: Massoud Kazemzadeh, Clara City, MN (US)

Correspondence Address: DICKE, BILLIG & CZAJA, FIFTH STREET TOWERS, 100 SOUTH FIFTH STREET, SUITE 2250, MINNEAPOLIS, MN, 55402, US

(21) Appl. No.: 12/634,398

(22) Filed: Dec. 9, 2009

Related U.S. Application Data
(63) Continuation-in-part of application No. 10/960,437, filed on Oct. 6, 2004, now abandoned.
(60) Provisional application No. 60/509,000, filed on Oct. 6, 2003.

(51) Int. Cl. A21D 2/26; A21D 8/02; A21D 13/00; A23L 1/305; A23L 1/308; A23P 1/14; A21D 2/04

(52) U.S. Cl. 426/448; 426/498

(57) ABSTRACT

The present invention relates to a method or processing technique as well as the product achieved there from for the manufacturing of high protein, high fiber, low carbohydrate snacks, cereals, and food items in which the end product will demonstrate low bulk density and/or a light crunchy texture. The product may be made up of mixtures of various sources of proteins such as Milk protein, Whey protein, Soya protein, Meat protein mixed with various portions of grains and hydrocolloids and processed in such manner where the product, utilizing the incorporation of various gasses into the plasticizing agent and then distributed within the matrix under low or high pressure such as cooking extrusion or forming extruder for the purpose of expanding the matrix of the food when exiting the die and the pressure is released. During the baking process, such expansion takes place when the gas infused plasticizer is distributed within the dough and further expands within the dough as it is being baked. The presence of heat further assists in the expansion of the dough by turning water into steam within the dough and expanding the gas within the plasticizer, thus resulting in the expansion of the food particle resulting in final very light crunchy texture product thus achieving a very low bulk density.

The present application is a continuation of U.S. patent application Ser. No. 10/960,437, filed Oct. 6, 2004, which claims benefit of priority from U.S. Provisional Patent Application No. 60/509,000, filed Oct. 6, 2003, which are incorporated herein in their entirety by reference.

### FIELD OF THE INVENTION

The present invention relates generally to a method of preparing food products. More particularly, the present invention relates to a method of preparing extruded food products in which gas has been infused.

### BACKGROUND OF THE INVENTION

Today the population of most of the developed countries and cities are facing a great epidemic of obesity and overweight due to lack of proper diet and exercise. The standard line of counseling for such individuals has been to eat less and exercise more. This line of counseling is no longer a valid path of recommendation due to the problem of obesity becoming epidemic in the U.S. resulting in a four-fold increase adult onset diabetes from 1975 to 2003.

The real true answer for weight control is to reduce caloric intake by eating smaller portions and reducing simple carbohydrates and sugars in the diet. Yet, despite the advice of doctors and nutritionists, we still have the majority of our snacks and cereals made up of starch-based foods and sugars, which are detrimental to the health of our population.

This miscommunication can be attributed to two specific problems, the most important of which is the lack of availability of low carbohydrate foods for each meal, especially for breakfast and snacks. The second problem is continued bombardment of the advertising, which promotes the good taste associated with high fat and simple carbohydrate foods.

According to the USDA statistics in 2002, 30% of the American population is obese. The trend has now reached epidemic proportions resulting in increase in adult onset diabetes and heart disease, mentioning only two of many problems facing the next generation. This pattern of eating has also resulted in large number of children today who are grossly obese, thus setting a future life for these individuals of a constant battle with obesity.

The focus on simple carbohydrates as the enemy to weight loss occurred because the low-fat diets of the 1980s and the 1990s failed consumers who mistakenly believed that consumption of low-fat products was a license to eat voraciously while paying no attention to the amount of sugars and simple carbohydrates being consumed.

Today many people find irresistible the basis of “low carbohydrate diets: eating as much protein as desired-including steaks, eggs, and other fatty foods that they had previously been told by media reports and medical practitioners to shun-and still being able to lose weight, so long as intake of carbohydrates is strictly limited.” (Kieby J., Dieting for Dummies. Foster City, Calif. IDG Books Worldwide; 1996:240-243).

This philosophy of losing weight, which does work for majority of people who wish to lose weight, takes in to account the glycemic index value, which tends to be very high for sugars and simple carbohydrates and very low for proteins and fats and fibers.

The concept of low carbohydrate diets has become the most acceptable solution for the majority of the population in the U.S. This includes individuals who are grossly obese as well as children and those who wish to maintain their weight and shape. Another field, which has supported this thought, has been the sport/nutrition centers, which promote high protein drinks for muscle builders and weight management via type of food intake and trainings.

When studying the pathway of energy consumed for the human digestion system and the intake of various components of foods such as fats, proteins 15 simple carbohydrates, sugars and insoluble carbohydrates, it becomes evident that although each component can generate a certain predetermined energy output per unit of weight, nevertheless, the results and the quality of energy being converted is not the same between various components according to “Benders' Dictionary of Nutrition and Food Technology,” CRC Press 1999.

Energy is the ability to do work. While it is usual to speak of the calorie content of a food, it is more correct to refer to the energy content or yield. The total chemical energy in a food, as released by complete combustion, is considered as gross energy from Calorimeter. Allowing for loss in the urine due to incomplete combustion in the body (e.g. urea from the incomplete combustion of proteins) gives metabolizable energy. Allowing for the loss due to diet-induced thermo genesis gives net energy, i.e. the actual amount available for use in the body.

Energy Balance is the difference between intake of energy from foods and energy expenditure on basic metabolism and physical activity. Positive energy balance leads to increase in body tissue, the normal process of growth. In adults positive energy balance leads to creation of body reserves of fat, resulting in overweight and obesity. Negative energy balance leads to utilization of body reserves of fat and protein, resulting in wasting and under nutrition.

Energy Conversion Factors relates to various factors, which can be used to calculate energy yields of foodstuffs. The following factors are generally used to calculate the food values. Carbohydrates 4 kcal/g, Fat 9 kcal/g, Proteins 4 kcal/g, Alcohol 7-kcal/g and sugar alcohol 2.4 kcal/g while organic acids are 3 kcal/g.

Understanding the above definitions and the main components of the food, it becomes obvious that our health and weight management can be achieved from the correct combination and ratio of the Proteins, Simple Carbohydrates and Fats.

According to Dean Omish, MD. in Lifestyle Program, high protein diets help people lose weight because they are based partially on science, which is what makes them seductive. The high-protein advocates are right when they say that people in the United States eat too many simple carbohydrates like sugars, white flour, and white rice. These foods are absorbed quickly, causing blood sugar to spike, which in turn provokes an insulin response that accelerates the conversion of calories to fat. There is a clear benefit to reducing the intake of simple carbohydrates, especially to people who are sensitive to them.

So the diagnosis is correct: we are eating too many simple carbohydrates. But the cure is wrong. The solution is not to go from simple carbohydrates to pork rinds and bacon, but from simple carbohydrates to whole foods with complex carbohydrates like whole-wheat, brown rice, and fruits, vegetables, grains and legumes in their natural forms.

These foods are naturally high in fiber, which slows their absorption, preventing a rapid rise in blood sugar. Fiber also fills you up before you eat too many calories, whereas you can eat large amounts of sugar without feeling full. Best of all, these foods contain at least 1,000 substances that have anti-cancer, anti-heart disease, and anti-aging properties.”

Then one may ask why are snacks and cereals as well as most of our 15 food items consumed on a daily basis between meals are so heavily filled with fats, simple carbohydrates, and sugars. The only logical explanation is that the most inexpensive component of these foods are starches, sugars and fats while the most expensive components are fiber, proteins and complex carbohydrates.

Another main reason for cereals and snacks being made up of these simple carbohydrates and fats is the difficulty of making snack products from high proteins and fibers. Snacks and cereals usually have a very light crunchy texture, which is very pleasing and habit forming for the consumer. The lack of such texture decreases the consumer's enjoyment of the food. No matter how tasty the product, if a light crunchy texture is missing, the final response of the consumer is to reject the product.

The processing techniques presently being used to produce such snacks and cereals do not lend themselves to the production of light and crunchy high protein and high fiber food products. Incorporation of a new set of techniques is needed to give the manufacturer the capability to produce good quality high protein and high fiber snacks and cereals.

Commercial processing of foods can involve heating, cooling, drying, application of chemicals, fermentation, irradiation, or various other treatments. Of these, heating is most common. This is commonly done for the inactivation of microorganisms, to inactivate endogenous enzymes that cause oxidative and hydrolytic changes in foods during storage, and to transform an unappealing blend of raw food ingredients into a wholesome and organoleptically appealing food. In addition, proteins such as bovine-β-lactoglobulin, α-lactalbumin, and soy protein, which sometimes cause allergenic or hypersensitive responses, can sometimes be rendered innocuous in this regard. Unfortunately, the beneficial effects achieved by heating proteinaceous foods are generally accompanied by changes that can adversely affect the nutritive values and functional properties of proteins.

Most food proteins are denatured when exposed to moderate heat treatment (60-90° C., for 1 hour or less). Extensive denaturation of proteins often results in insolubilization, which can impair those functional properties that are dependent on solubility. From nutritional standpoint partial denaturation of proteins often improves the digestibility and biological availability of essential amino acids. Several purified plant proteins and egg protein preparations, even though free of protease inhibitors, exhibit poor in vitro and in vivo digestibility.

Moderate heating improves their digestibility without developing toxic derivatives. Moderate heat treatment of foods also inactivates several enzymes, such as proteases, lipases, lipoxygenases, amylases, polyphenoloxidases, and other oxidative and hydrolytic enzymes. Failure to inactivate these enzymes properly will result in off flavors, rancidity, textural changes, and discoloration of food during storage.

Moderate heat treatment is particularly beneficial for plant proteins, because they usually contain proteinaceous anti-nutritional factors. Legume and oilseed proteins contain several trypsin and chymotrypsin inhibitors, which impair efficient digestion of protein and thus reduce their biological availability. Legume and oilseed proteins also contain lectins, which are glycoproteins. These are also known as phytohemagglutinins because they cause agglutination of red blood cells. Lectins exhibit a high binding affinity for carbohydrates. When consumed by humans, lectins impair protein digestion and cause intestinal malabsorption of other nutrients.

When proteins are heated above 200° C., as is commonly found on food surfaces during broiling, baking, and grilling, amino acid residues undergo decomposition and pyrolysis. Several of the pyrolysis products have been isolated and identified from broiled and grilled meats, and they are highly mutagenic as determined by the Ames test.

Several food proteins contain both intra- and intermolecular cross-links, such as disulfide bonds in globular proteins, demosine, and isodesmosine; and di- and trityrosine-type cross links in fibrous proteins such as keratin, elastin, resilin, and collagen. Heating of proteins in an alkaline pH, results in abstraction derivative of Cys, cystine, and phosphosoerine undergoes p-elimination reaction, leading to formation of highly reactive dehydroalanine residue (DHA). DHA formation can also occur via a one step mechanism without formation of the carbanion. Once formed, the highly reactive DHA residues react with nucleophilic groups, such as the α-amino group of lysyl residue, the thiol group of Cys residue, the α-amino group of ornithine (formed from decomposition of arginine), or a histidyl residue, resulting in cross linkage between the protein molecules.

Most snack and cereal manufacturers use extrusion cooking as an efficient and continuous process of manufacturing these items. The most favorable products, which can easily be manufactured with such systems, are the formulation of foods that are high in starch-based components. Starches are thermoplastic in nature and can easily be melted and formed under pressure and in the presence of plasticizing agent such as water to achieve a given product with low densities and light crunchy textures.

On the other hand, the protein portion of the formula is usually thermosetting in nature and is very difficult to control during processing. The same problem exists during the baking process where the plasticizers such as fat or water or various solutions are converted into steam during baking, thus rising the dough and making the texture of the finished product very light.

As the protein and fiber and fat portion of the formula increases, the extrusion cooking process becomes more difficult and hard to control. The bulk density of the product is increased rather than decreased, thus giving a harder texture to the end piece. The crunchy texture of the final product becomes hard and difficult to manage. It is with this fear, that most processors have a hard time using proteins in their products during high temperature extrusion. In the case of snack and cereal manufacturing, the high temperatures for a short time are necessary in order to be able to generate puffing, which is essential for the textural requirement of such products.

The bulk density of most snacks and cereals is within the lower end of the spectrum resulting in the finished product to be between 13-28 g/ml. To reduce the bulk density, the processing is designed so that the product is mixed with moisture and kept under very high pressures and temperatures of 1000 psi and 280° F. for a short time, so that when the precooked product within the extruder exits the die of the extruder the vapor pressure is so great that will force the matrix to expand and thus release the pressure of the vapor and expand the dough to much lower bulk density.

During extrusion cooking, the dough may be subjected to very high temperatures of 300-400° F. for few seconds. Under normal formulations the starch or the carbohydrate portion of the formula is the dominating portion of the dough matrix. Thus, the dough tends to react positively to temperatures by super-heating the moisture portion within the dough and expanding the dough once the moisture and pressure are released at the die. Starches, being thermoplastic, tend to react favorably to melting at high temperatures while moisture is present and expanding to reduce the bulk density.

If any sugars or components of food that are likely to go through browning or carmelization at lower temperatures are present in the high protein formulas, the dough tends to go through a carmelization or browning reaction at a much lower temperature, which in most cases is an exothermic reaction. This would mean that the extrusion cooking process will have a run-away temperature during processing and cannot easily be controlled. This method results in the final product to start at temperatures of 265-285° F. and within few minutes rising to over 300° F. This temperature increase will make the proteins insoluble and will result in cross-linking of such proteins with each other and other components of the dough.

If the food dough is extruded at lower temperatures the cooking is accomplished, but the expansion of the high protein medium due to super-heated moisture is unattained and minimized. The final product results in high bulk density and is usually hard and difficult for consumption. The addition of proteins also tends to require a much greater volume of water or plasticizer in order to hydrate it into a dough form, thus making the process even more difficult.

Due to extrusions short residence time of 40-60 seconds and the dynamic nature of the process, chemical leavenings are not practical and their effects are very limited. Also, as the temperature of the protein matrix increases, the solubility of the protein molecules decrease, thus resulting in a condition of high temperature. This condition is good for expansion due to vapor pressure, but the increase in the strength of the protein matrix opposing the expansion at these temperatures results in a heavy and un-puffed product with a hard texture.

The greatest challenge for the food processing engineers in today's market is to be able to produce light textural snacks and cereals with low carbohydrate, high protein and fiber content while keeping the temperature below 280° F. within an extrusion cooking system and be able to expand the product to achieve lighter textures and lower bulk density. It is this specific challenge, in the processing of low carbohydrate, high protein and fiber food items that is met with this invention.

During the oven baking of such dough, similar problems will occur with challenges of how to improve the textural profile of the final product without having to add abundant amounts of leavening agents, which will alter the taste and acceptability of the final product. The addition of a gas infused plasticizing agent will not only control the constant rising of the dough, but will insure the lowering of bulk density and lightening of the textural profile.

### SUMMARY OF THE INVENTION

An embodiment of the invention is directed to a method of processing at least one protein source, at least one grain and at least one hydrocolloid in which gas is incorporated during the extrusion process. Food products produced according to this method exhibit a very light crunchy texture.

### DETAILED DESCRIPTION OF THE PREFERRED EMBODIMENTS

The ability to generate small consistent bubbles within an extrusion system or in baking dough has always been a limiting factor among the processing engineers within various fields of food manufacturing. However, with new advanced technology, this task has become easy and reliable but with one speculation, which is to incorporate the bubbles within the plasticizer agent before it is injected into the extruder or incorporated into the dough. This technique makes the production of micro bubbles more reliable within a more liquid phase of the recipe and thus more dependable for consistency.

This invention utilizes the cooking extrusion process and, to a lesser degree, the baking process to produce high protein, high fiber, low carbohydrate, snacks and cereals with low bulk density and light crunchy texture. Since high temperature extrusion under this condition utilizes the lower end of processing temperatures of about 200° F. to about 285° F., the high protein dough is not affected by runaway reactions, yet the expansion force exists within the plasticizer to produce a lighter texture product. It is able to provide conditions and energy required for the high protein dough mixture to go through a glass transition temperature and denaturation phase, before reaching the texturization temperature.

This process is further assisted by the injection of gas-incorporated water inside the dough as a source of plasticizer. The gas-incorporated water provides the micro bubbles, which are required to evenly distribute the gas within the dough. At the point of exit, where the pressure is released, the gasses trapped within the dough will cause the semi-cooked dough to expand and generate textures that are light in crunch. This process also allows the final product t have a low bulk density, which is so desired by the snack and cereal industry using a high protein low carbohydrate recipe.

Similar reaction with lower results can be realized in baking processes where the dough containing high protein and low carbohydrate is formed using a highly charged plasticizer with gases such as CO₂. This process allows the various components of the recipe to hydrate as well as distribute the micro bubbles within its matrix captured under the strength of the crosslinking components of the dough. When this dough is formed and heated, the leavening agents begin to expand the dough, the gases within the micro-bubble of the dough also begin to expand, and the dough tends to increase in size and produce a lower bulk density than if the gas was not used. We have been able to demonstrate up to 28% increase in volume by using a highly charged plasticizer in a high protein dough.

Incorporating gases within the extrusion system has been done for various processes. However, the major difficulty in this component of extrusion process has always been the ability of controlling the bubble size of the gas within the dough matrix so that at the time of exit from the die, the expansion of the dough can be uniform and consistent. The utilization of gas incorporation into the plasticizing agent combined with dough containing a high protein profile makes this process viable and the only option for the manufacturing of high protein cereals and snacks.

While food ingredients such as high-protein ingredients increase the health benefits of the food products that contain the ingredients, the high-protein ingredients tend to increase the density of the food products. The increased density of the food products may make it difficult for persons to chew such food products. Various techniques have been used to reduce the density of food products such that the healthful benefits may be enjoyed while the food products have a desired texture when chewed.

One technique to reduce the density of the food products is to use a chemical leavening agent such as yeast or baking powder. These chemical leavening agents cause the production of a gas such as CO₂ during the process of preparing the food product. However, the expansion and activation of yeast is limited based upon a variety of factors such as time, temperature, amount of water and sugar to initiate growth of the yeast.

For a chemical reaction using baking powder, the reaction of basic and acidic ingredients causes the formation of CO₂. The amount of expansion produced by chemical leavening agents depends significantly upon the cooking time and temperature. The relatively short heating time in typical extruders precludes the use of chemical leavening agents because the chemical leavening agents do not have sufficient time to produce a desired level of expansion.

Additionally, the chemical leavening agents do not perform well when used with food products that have a protein concentration of more than about 20 percent by weight. The protein generates a great deal of internal force within the dough, which reduces the possibility of gases formed by the chemical leavening agents to allow expansion to produce a significant expansion within the matrix. The high protein food products thereby have a harder texture.

It is also known that gas may be introduced into a food product by adding a foaming agent to the food product during the preparation process and then subjecting the food product to a high-speed blending process, which causes air to be drawn into the food product.

This process produces significantly different size air bubbles to be provided in the food product compared to the air bubbles that are produced using the gas infused plasticizer, which is discussed in more detail below. Because of the preceding differences, persons of ordinary skill in the art would not view these two techniques as being similar or producing similar results.

Gas infused plasticizers may use a variety of easily volatile gases. For producing a variety of food products, the gases should be volatile at room temperature. For other embodiments, the gases should become volatile at temperatures of between about 45 and 95° C. The gases should also be food grade since the gases are being incorporated into food products that are intended for consumption.

Examples of suitable gases include CO₂, air, peroxide, alcohols and ethers. However, a person of skill in the art will appreciate that other gases may be used in conjunction with the concepts of the current invention.

The concentration of the gas that is infused into the plasticizer may be provided at a concentration of up to about 40 percent by weight. In other embodiments, the concentration of gas infused in the plasticizer is between about 0.5 and 38 percent by weight. In certain embodiments, the concentration of gas infused into the plasticizer is between about 12 and 25 percent by weight.

The plasticizer used to infuse the gas within them should be imitable with the dough being prepared. By this, it is meant that the plasticizer does not increase or decrease the pH of the dough by more than about 2.5. In certain embodiments, the change of pH of the dough caused by the plasticizer is less than about 1.0.

Care must be taken when selecting the level of gas that is introduced into the dough because using an excess amount of gas or using an incompatible plasticizer may result in burning the high protein matrix during cooking Such a result would decrease the quality of the food product such that consumption would not be desired.

Liquid plasticizers are typically used at a concentration of between about 10 and 30 percent by weight when extrusion is used and between about 30 and 45 percent by weight when baking is used.

In certain embodiments, the air cells produced by the techniques of this invention are between about 2 and 3,000 microns. In other embodiments, the air cells range in size from 2 to about 1,000 microns.

Once the gas is infused into the plasticizer and the gas-infused plasticizer is mixed with the raw powder to form the dough, the gas is well mixed within the high protein matrix to form a well developed dough. Such a process allows a very good distribution of gas in micro forms to all aspects of the dough matrix.

When the gas is exposed to the high pressure and high temperature within the extruder, the gas tends to expand to a point where it forms smaller chambers of expansion, which are called air bubbles. The process creates micro bubbles at the cross-section of the end product resulting in a light textured end product.

There may be some bleeding of one gas cell to another to form larger cells or air bubbles. On average, the cell formations are much smaller than they would be if a chemical leavening agent was used.

Good control of the amount and the size of the air bubble and its uniform distribution in molecular level directly affects the texture of the finished product regardless of how strong a matrix or how high a protein level it is dispersed in. The quantity of gases is also relevant to the textural changes.

The smaller, more uniform and abundant the air bubbles within the high protein matrix will result both in the extrusion and baking processes to lighter textured end product and will give a better mouthfeel similar to starch-based matrices, which is the common standard of public reference in cereals and snacks.

To further develop the dough so that the stretchability and expansion can be further realized during the exit from the die of the cooking extruder, we were able to use some hydrocolloids such as gums, fiber gums, and gelatins within the dough to add to the strength of the high protein dough and provide the weakening of the matrix so that the gas can expand and allow the product to form a light texture.

Two major sources of protein were utilized during our studies, one being the protein from legumes such as Soya isolate and the second was whey protein isolate. The type of gums and hydrocolloids used were the gum Arabic, Xanthan gum, pre-gelled corn starch, pre-gelled potato, and tapioca starch, as well as number of other sources of ingredients, which provide stretch ability and matrix building capacity to the dough. Under all conditions the gas-infused plasticizers tend to reduce the bulk density of the product with no side effects such as off flavor or taste by about 30% to about 50%. The final textural acceptability of the finished product was improved by about 2 to 3 times the normal condition if this process was not adopted.

Since high temperatures are avoided using this technique, the utilization of proteins from sources that contain reducing sugars, such as whey, which were not previously possible, can be achieved. The low temperatures, while denaturing the proteins, stay far below the texturization point of the proteins, thus allowing the dough to be fully developed using the hydrating force of the protein matrix and other dough developing compounds of the dough such as hydrocolloid soluble fibers and gelling agents, such as variations of CMC (carboxymethyl cellulose), all at lower temperatures but containing a highly gas infused matrix. This matrix readily expands under slight heating of the dough and during the release of pressure at the die of an extrusion system.

To fully verify the effects of gas infused dough during the cooking extrusion and baking, we tested the following protein sources at various levels of concentration with tap water as well as with highly charged water with CO₂.

TABLE 1

| Ingredients* | sample 1 | 2 | 3 | 4 | 5 |
|---|---|---|---|---|---|
| Soya Isolate | 30% | 40% | 50% | 60% | 70% |
| Corn Flour | 55% | 45% | 35% | 25% | 15% |
| Corn Starch | 15% | 15% | 15% | 15% | 15% |
| (pre-gelled) | | | | | |
| Total | 100% | 100% | 100% | 100% | 100% |
| Bulk Density | 13 g/ml | 14 g/ml | 17 g/ml | 20 g/ml | 24 g/ml |
| w/gas infusion | | | | | |
| Bulk Density | 19 g/ml | 24 g/ml | 34 g/ml | 39 g/ml | 40 g/ml |
| w/o gas infusion | | | | | |

TABLE 2

| Ingredients* | sample 1 | 2 | 3 | 4 | 5 |
|---|---|---|---|---|---|
| Whey Isolate | 30% | 40% | 50% | 60% | 70% |
| Corn Flour | 55% | 45% | 35% | 25% | 15% |
| Corn Starch | 15% | 15% | 15% | 15% | 15% |
| (pre-gelled) | | | | | |
| Total | 100% | 100% | 100% | 100% | 100% |
| Bulk Density | 14 g/ml | 17 g/ml | 20 g/ml | 23 g/ml | 28 g/ml |
| w/gas infusion | | | | | |
| Bulk Density | 18 g/ml | 25 g/ml | 31 g/ml | 34 g/ml | 39 g/ml |
| w/o gas infusion | | | | | |

From the above findings, it is evident that the addition of gas to the dough will result in higher expansion ratio and thus lower bulk density.

The raw ingredients are mixed in a form of flour to a substantially homogenized mixture. The mixture is then introduced to a chamber where it is mixed with steam or moisture.

The mixture is then introduced to the feeding zone of the cooking extruder such as twin-screw extruder. Carbonated or gas infused water is injected into the extruder. With low carbohydrate, high protein flour, about 2 to about 2.5 times the water may be needed.

The extruder then mixes the components together to generate dough under pressure, which is kneaded to a substantially homogenous state. The dough is then conveyed to a high pressure and shear zone within the extruder. In this zone, the dough temperature is raised to about 250 to about 350° F.

The high sheared and pressured dough with micro bubbles of the gas imbedded within its matrix is well distributed within its heated dough and is then introduced to the die area of the extruder. By this time the dough temperature may be between about 250 to about 350° F. and the water vapors and the gas is under pressures of over about 1,000 psi.

The pressurized and gas infused dough is then pushed through a die opening resulting in formation of a shape and release of pressure to the atmosphere. The gas and vapor within the dough matrix expands while conforming to the die shape.

The expanded product is then cut either at the die or formed into a ribbon and cut later by a rotary cutter to form the final product. The cut pieces are then transferred to a toaster or drier to further develop the product taste and texture. The finished puffed product is then cooled to room temperature and is ready to be consumed.

Alternatively, the food product may be produced using a baking process as set forth below. The raw ingredients are mixed in a form of flour to a substantially homogenized mixture. To the mixture of flour, the highly charged plasticizing agent is introduced and mixed rapidly. The temperature of the plasticizing agent can be in the range of conventional room temperature.

Dough is formed with the infused gas in a substantially homogenous format initiating the leavening agents either chemical or natural. The gas infused dough is then placed in formers to produce and form the food particulate. The formed dough is then cut to the appropriate shape and size.

The cut pieces are then introduced into a 5% sodium hydroxide solution to produce pretzels or sprayed with acidic solution to produce shiny surface. The coated pieces are then to form a very fast rising dough under conventional baking conditions.

The liquid treated surface of the dough is then sprinkled with various products nuts, sesame, or rock salts to give a specific taste to the final product. The baked dough is then dried to a final moisture content of about 2 to about 3% and is then cooled to room temperature where the food product is ready for consumption.

The above outlined process can be used for the making of high protein cookies pretzels crackers and bread sticks as well as number of other food products.

This technique although simple in application is able to generate great results in lowering the bulk density of the food product and most effectively can be used in the formulations which contain high protein and high fiber components which prevents the formed matrix from expanding.

This art used in the processing and baking of food articles is unique in its form and application due to the ability of gas infused plasticizer such as water which is needed in the making of a dough both for extrusion cooking as well as baking of pretzels and other food articles.

The gas infused plasticizer such as water infused with CO₂ at concentration values ranging from about 0.5 to about 38 percent of the volume of the plasticizer added to the flour will result in expansion of the food item to increase its total volume by almost 50 percent or more during processing and cooking and baking. Its most useful application is in the field of high protein low carbohydrate products, which have problems with light texture and good mouth feel.

This process is able to lighten the texture of the food item as well as reduce the bulk density and textural profile. The gas infused plasticizer can be used in recipes with protein levels ranging from about 2 to about 75 percent from sources like legume proteins, cereal proteins, whey and milk proteins as well as egg and other sources

The recipe may also contain fiber in concentration from about 0.1 to about 18 percent from various sources, and starch from various tubular and cereal and corn sources as well as sugars and minerals and vitamins. Use of nucleotides and other sources of amino acids in the recipe also can be improved in functionality using this processing outline.

It is contemplated that features disclosed in this application, as well as those described in the above applications incorporated by reference, can be mixed and matched to suit particular circumstances. Various other modifications and changes will be apparent to those of ordinary skill.

1. A method of preparing food products comprising:
preparing a mixture from at least one starch source, a protein source and a fiber source, wherein the at least one starch source is at a concentration of between about 5 and 85 percent by weight, and wherein the protein source is at a concentration of between about 5 and 60 percent by weight;
infusing a gas into a plasticizer at a concentration of between about 0.5 and 38 percent by volume to prepare gas infused plasticizer;
mixing the mixture with the gas infused plasticizer to form a dough, and wherein the plasticizer is at a concentration of between about 0.1 and 38 percent by weight;
forming the dough into a desired shape; and
cooking the dough using an extruder to form the high protein food products.

2. The method of claim 1, wherein the gas incorporated in the plasticizer is oxygen, carbon dioxide, air or combinations thereof.

3. The method of claim 1, wherein the plasticizer is water.

4. The method of claim 1, wherein the dough is formed using the extruder.

5. The method of claim 1, wherein the dough is cooked in the extruder causes the dough to expand as it exits the extruder.

6. The method of claim 1, wherein cooking causes the dough to go through a glass transition temperature.

7. The method of claim 6, wherein cooking causes the dough to go through a denaturization phase.

8. The method of claim 7, wherein cooking causes the dough to reach a texturization temperature.

9. The method of claim 1, wherein the starch source comprises corn starch, corn flour, waxy maize starches, sago starch, cassaya starch, tapioca starch, potato starch, rice starch, or combinations thereof.

10. The method of claim 9, wherein the starch source is pre-gelatinized.

11. The method of claim 1, wherein the protein source is soy isolate, soy flour, soy protein, whey isolate, whey protein, legume protein, grain-based protein, milk-based protein, egg or combinations thereof.

12. The method of claim 1, wherein the fiber source is at a concentration of between about 1 and 18 percent by weight.

13. The method of claim 1, and further comprising adding a sweetener to the mixture.

14. The method of claim 1, wherein the gases are substantially evenly distributed in the dough.

15. The method of claim 1, and further comprising adding a leavening agent to the mixture.

16. The method of claim 1, wherein the high protein food products have a moisture content of less than about 5 percent by weight.

17. The method of claim 1, wherein the dough is cooked at a temperature of between about 200 and 285° F.
